(19) United States
(12) Patent Application Publication
(10) Pub. No.: US 2010/0060410 A1
(43) Pub. Date: Mar. 11, 2010

(54) LOCK FOR A PORTABLE DEVICE

(75) Inventor: Thibaut Wirth, Coublevie (FR)

Correspondence Address: DARBY & DARBY P.C., P.O. BOX 770, Church Street Station, New York, NY, 10008-0770, US

(73) Assignee: TRIXELL S.A.S., Moirans (FR)

(21) Appl. No.: 12/513,461

(22) PCT Filed: Oct. 31, 2007
(86) PCT No.: PCT/EP2007/061777

§ 371 Date: Aug. 20, 2009

(30) Foreign Application Priority Data
Nov. 2, 2006 (FR) 06/54695

(51) Int. Cl. G05B 19/00

(52) U.S. Cl. 340/5.2

(57) ABSTRACT

The present invention relates to an antitheft device for a wireless portable device designed to be in contact with a docking device including a lockable attachment apparatus for attaching the portable device to the docking device. The antitheft device according to the invention comprises an electromechanical system commanding the unlocking of the lockable attachment apparatus based on an electric signal. The electric signal is disabled by a command supplied by a user interface unit. The invention is notably used as an antitheft device for a wireless, portable X-ray sensor associated with a docking station.

### CROSS-REFERENCE TO PRIOR APPLICATION

This is a U.S. National Phase Application under 35 U.S.C. §371 of International Application no. PCT/EP2007/061777, filed Oct. 31, 2007, and claims benefit of French Patent Application No. 06/54695, filed Nov. 2, 2006, both of which are incorporated herein. The International Application was published in French on May 8, 2008 as WO 2008/053022 under PCT Article 21 (2).

### BACKGROUND OF THE INVENTION

The present invention relates to an antitheft device for a wireless portable device. The invention is notably used as an antitheft device for a wireless, portable X-ray sensor associated with a docking station.

### BRIEF DESCRIPTION OF THE PRIOR ART

In the field of medical imaging, the trend in imaging device toward light, portable device generates a new requirement concerning protection against the theft of these apparatus. For example, a wireless portable X-ray sensor is an extremely costly object that is very easy to steal. An antitheft system for such a sensor should satisfy two main criteria which are:
discourage potential thieves by the technical difficulty of the theft,
allow the sensor to remain useable by several people by limiting the constraints of use.

Hitherto, the only antitheft systems used are like those used for laptop computers: a usually metal cable attaches the laptop computer and connects a more imposing element, such as for example a table, having a mechanical key as the only unlocking means.

The main disadvantages of these antitheft devices are as follows:
a mechanical and manual action is necessary to lock the antitheft device with the risk that the person puts down the sensor without thinking of locking it,
unlocking the antitheft device requires being in possession of the key, which means having the key permanently on one's person with a not inconsiderable risk of loss,
use by several people involves a multiplication of the keys and therefore has an increased risk of these keys being lost and possibly a risk of confusion between various keys or a risk of dishonest use of the key if the latter falls into bad hands.

### SUMMARY OF THE INVENTION

One object of the invention is notably to alleviate the aforementioned disadvantages. For this purpose, the subject of the invention is an antitheft device for a portable device designed to be in contact with a docking device. The docking device comprises means for attaching the portable device to the docking device. The antitheft device comprises an electromechanical system commanding the unlocking of the attachment means based on an electric signal. The electric signal may be disabled by a command supplied by a software unit.

The electric signal may be disabled based on a disable message sent by the software unit to the docking device. The disable message may generate a signal, amplified by a suitable interface. The amplified signal opens a supply circuit of the electromechanical system.

The electric signal may be enabled based on an enable message sent by the software unit to the docking device. The enable message generates a signal amplified by a suitable interface. The amplified signal closes the supply circuit of the electromechanical system.

The entry of a password via the software unit may cause the enable message to be sent by the software unit. The entry of a password secures the use of the portable device.

The disable message may be sent automatically by the software unit in compliance with a programmable time criterion.

The electromechanical system may comprise at least one electromagnet acting on a magnet connected to the attachment means and allowing the attachment means to be opened.

The electric signal is generated for example by a button placed on the docking device.

The electromechanical system may comprise a mechanical unlocking means.

The portable device may be an X-ray sensor and the docking device is for example an X-ray sensor docking station.

The software unit may be a computer, comprising a medical imaging system management software program, connected to the docking station via a link.

The main advantages of the invention are notably that it is simple to use and to apply and also not very costly to produce.

### BRIEF DESCRIPTION OF THE DRAWINGS

Other features and advantages of embodiments of the invention will emerge with the aid of the following description given as an illustration and not limiting, and produced with respect to the appended drawings which represent:

FIG. 1: a general diagram of a medical imaging system,

FIG. 2a: schematic representation of the device for attaching a sensor to a docking station in the unlocked position,

FIG. 2b: schematic representation of the device for attaching the sensor to a docking station in the locked position,

FIG. 3: schematic representation of the device for locking/unlocking the sensor on the docking station,

FIG. 4: block diagram of how the device for locking/unlocking the sensor operates in various configurations.

### DETAILED DESCRIPTION

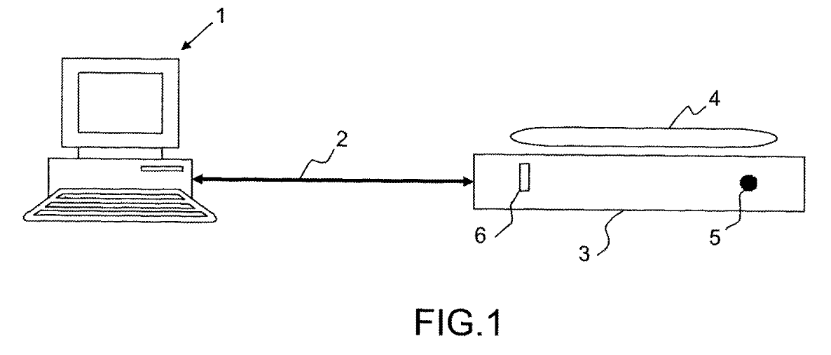

FIG. 1 represents a medical imaging system. This system comprises a software unit 1 for managing the medical imaging system. This software unit 1 may be a computer 1 comprising a medical imaging system management software program. The computer 1 communicates via a link 2 with a docking station 3 for a sensor 4. The link 2 between the docking station 3 and the computer 1 may be a wire or optical link or any other type of link allowing an interchange of data between two electronic devices. The docking station 3 may for example be a station for recharging the batteries of the sensor 4, also being used for the sensor 4 as a communication relay to the computer 1 for managing the medical imaging system. The sensor 4, when idle, is therefore placed on the docking station 3. The docking station 3 has a device for attaching the sensor 4 when the latter is placed in contact with it. This attaching device is associated with a device according to one or more embodiments of the invention for locking and unlocking the sensor 4 when it is placed on the docking station 3. The sensor 4 may be unlocked either with the aid of a side button 5, which may be a pushbutton, or with the aid of a key to be inserted into a lock 6 positioned on the docking station 3.

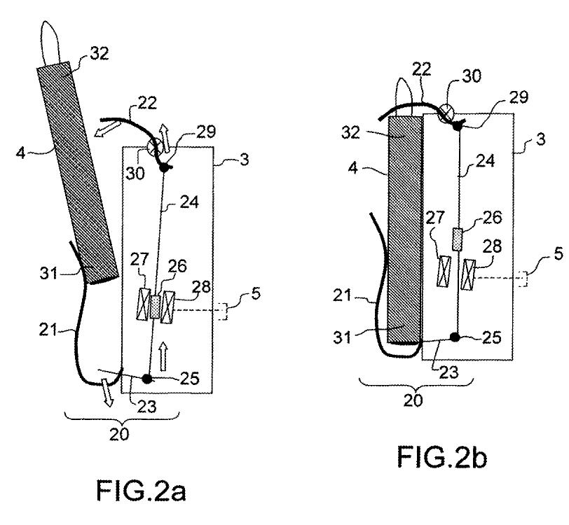

FIGS. 2a and 2b represent an example of a device for attaching the sensor 4 to the docking station 3. FIG. 2a represents the sensor 4 in an unlocked position relative to the docking station 3. FIG. 2b for its part represents the sensor 4 locked to the docking station 3. The sensor 4, in FIGS. 2a and 2b, is in the form of a small case, comprising a first end 31 and a second end 32 that is placed on the docking station 3. The docking station 3, represented in the form of a rectangular block, is provided with an attaching device 20 allowing the sensor 4 to be held when the latter is placed on the docking station 3. The device 20 for attaching the sensor 4 to the docking station 3 is, in the context of the device according to one or more embodiments of the invention, locked when the sensor 4 is placed on the docking station 3 so that the sensor 4 cannot be removed from the docking station 3 without carrying out a particular unlocking procedure. A button 5, positioned for example on the side portion of the docking station 3, may be used to release the sensor 4 simply by pressing it. This pressing action makes it possible to actuate the attaching device 20 so that it releases the sensor 4. The button 5 may be placed inconspicuously so that only the person knowing of its existence can actuate it. This makes it possible to reduce the number of people capable of taking the sensor 4 off the docking station 3.

The device 20 for attaching the sensor 4 to the docking station 3 may comprise two rigid strips 21, 22 making it possible to hold the sensor 4 in contact with the docking station 3. The sensor 4 is slid between the first strip 21 and the docking station 3 in order to be pressed onto the docking station 3. The first strip 21 is secured to the docking station 3. When the first end 31 of the sensor 4 is positioned between the first strip 21 and the docking station 3, the sensor 4 applies pressure to a first rod 23 connected to a second rod 24 via a first rotatable shaft 25. The rotary movement of the first rod 23 causes a translation movement of the second rod 24. A magnet 26 is mounted on the second rod 24. When the device 20 for attaching the sensor 4 is in an open position as shown in FIG. 2a, the magnet 26 is positioned between two electromagnets 27, 28. When the device 20 for attaching the sensor 4 closes, the magnet 26 is moved in translation by the second rod 24: it is no longer positioned between the two electromagnets 27, 28. The second rod 24, when the device 20 attaching the sensor 4 is closed, operates, in its translation movement, a second rotatable shaft 29 secured to the second rod 24 and the second strip 22. The translation movement of the second rod 24 will, via the second rotation shaft 29, cause the second strip 22 to rotate about a third rotation shaft 30 secured to the docking station 3. The second strip 22 will then cover the second end 32 of the sensor 4 thereby locking the sensor 4 to the docking station 3.

When the device 20 for attaching the sensor 4 is closed, pressing the button 5 makes it possible to supply the electromagnets 27, 28 which attract the magnet 26 thereby creating a translation movement of the rod 24 in the direction opposite to the translation movement used for the closure of the device 20 for attaching the sensor 4. This translation movement causes the second strip 22 to rotate about the third rotation shaft 30, thereby releasing the sensor 4.

The attaching device 20 advantageously allows the sensor 4 to be locked automatically when the latter is placed on the docking station 3. Picking up the sensor 4 requires a simple manual operation which may include pressing the button 5 then withdrawing the sensor 4 from the attaching device 20 opened by virtue of the pressure on the button 5.

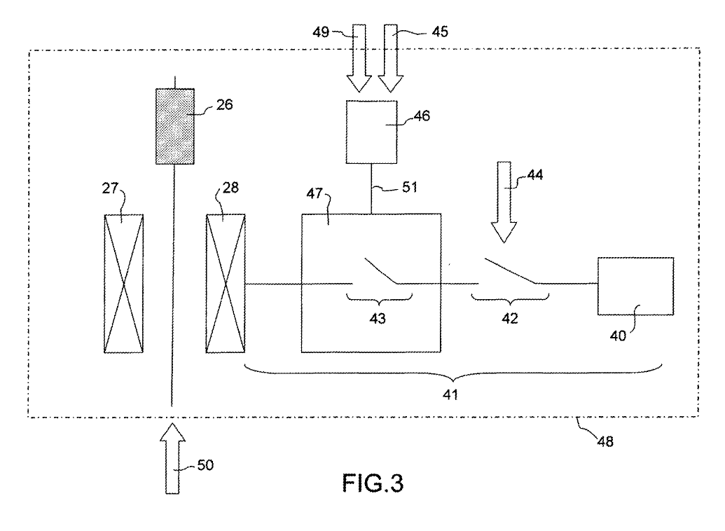

FIG. 3 shows the use of an electromechanical device 48 according to an embodiment of the invention for locking and unlocking the sensor 4 when it is placed on the docking station 3, locked by the device 20 for attaching the sensor 4. The locking and unlocking device 48 according to an embodiment of the invention may for example comprise a supply 40 making it possible to supply the electromagnets 27, 28 when the supply circuit 41 is closed. The supply circuit 41 has for example two switches 42, 43. The first switch 42 closes on a pressure of the button 5 which generates an electric signal 44 for this purpose. The closure of the first switch 42 causes the two electromagnets 27, 28 to be electrically supplied, thereby unlocking the sensor 4 as shown in FIG. 2a. The unlocking of the sensor carried out by means of the button 5 is therefore an electrical unlocking action.

The second switch 43 is opened only when disabling of electromagnetic unlocking has been requested. The unlocking of the sensor 4, with the aid of the button 5, may be disabled by means of a disable message 45 sent from the computer 1 to the station 3. Once this disable message 45 has been received by the docking station 3, a suitable interface 46 converts this message into an amplified signal 51 transmitted to a command module 47 which opens the switch 43. In this case, pressing the button 5 has no effect on unlocking the sensor 4 so long as an enable message 49 has not been sent by the computer 1.

When the docking station 3 receives an enable message 49, the interface 46 converts this enable message 49 into an amplified signal 51 transmitted to the command module 47 so that it closes the switch 43. Once the switch 43 has been closed, simply pressing the button 5 makes it possible to unlock the sensor 4.

The disable message 45 may be sent by a user via a man-machine interface of the medical imaging system management software program. The disable message may also be sent automatically by the medical imaging system management software program to a programmable criterion in the medical imaging system management software program. This criterion may for example be a temporal criterion such as a time and a date for the beginning of the disabled state or else a determined elapsed time from the last use of the sensor 4. The operation of the disabled state in automatic or manual mode may be programmable in the medical imaging system management software program. The enable message 49 may be sent on an action of the user from the medical imaging system management software program or else by entering a password for example. This makes it possible to secure the use of the portable device: specifically, only people knowing the medical imaging system management software program or else the password may enable the unlocking of the sensor 4.

When the message 49 for enabling unlocking cannot be sent, electric unlocking via the button 5 having been placed in the disabled state, a mechanical unlocking means 50 makes it possible, for example by means of a key, to be made to operate in the lock 6 of the docking station 3, to release the sensor 4 from the station 3. The key may act for example by operating a mechanical system not shown which makes it possible to pull the rod 24 in order to position the magnet 26 between the two electromagnets 27, 28 which causes the unlocking of the sensor 4 as shown in FIG. 2a. This therefore advantageously makes it possible to unlock the sensor 4 when the link 2 between the computer and the docking station 3 does not work or the computer password has been lost for example.

The device according to one or more embodiments of the invention therefore makes it possible to have several means for locking and unlocking the sensor 4 depending on various usage situations.

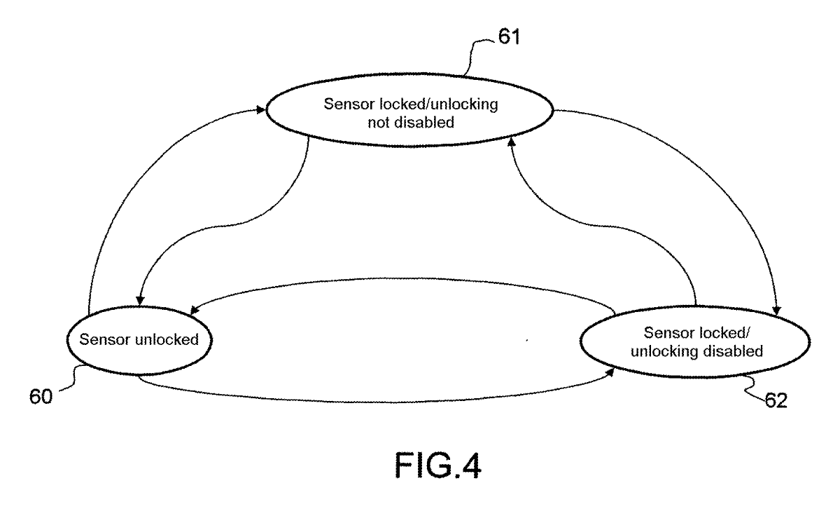

FIG. 4 represents a block diagram of the procedures to be carried out in order to release the sensor 4 depending on the locked state of the latter. The general principle of the device according to the invention is to be able to use the antitheft device in at least three different ways:
in standard use, pressing the button 5 of the station 3 is sufficient to unlock the sensor 4 so as to be able to take it out of the docking station 3,
in a more secure method of use, the unlocking action is disabled by means of the button 5,
in a degraded mode of use, in the event of a malfunction for example, it is possible to release the sensor with the aid of a key.

The sensor 4 may be in several states relating to its being locked on the station 3: a first state may be that in which the sensor being unlocked 60 when it is outside the docking station for example or when the attaching device 20 is not locking the sensor 4 on the docking station 3. A second state 61 may correspond to the situation in which the sensor 4 is locked on the docking station 3, but unlocking is not disabled, which, for example, is typically the case with standard use of the antitheft device: it is then sufficient to press the button 5 to release the sensor 4. A third state 62 may correspond to the state in which the sensor is locked with unlocking disabled. This third state 62 corresponds to a secure use of the sensor 4, an action of an operator on the computer 1 being necessary to remove the disabled state. The sensor 4 may be placed in this third state 62 when it is being little used for example.

When the sensor 4 is in the unlocked state 60 and it is placed on the docking station 3:
either it switches to the state 61, sensor locked and unlocking not disabled,
or it switches to the state 62, sensor locked and unlocking disabled if the station 3 received, prior to the sensor 4 being placed on it, a disable message 45 from the computer 1.

When the sensor 4 is in the state 61, sensor locked and unlocking not disabled:
either the button 5 is simply pressed and the sensor 4 is unlocked; it then switches to the state 60, sensor unlocked,
or the station 3 receives the disable message 45 from the computer 1 and the sensor 4 then switches to the state 62, sensor locked and unlocking disabled.

When the sensor 4 is in the state 62, sensor locked and unlocking disabled:
either the user sends an enable message 49 via the computer 1, which switches the sensor to the state 61, sensor locked and unlocking not disabled,
or it is impossible to send an enable message 49 and in this case it is necessary to make use of a key in order to mechanically release the sensor 4 from the station 3. The sensor 4 is then in the state 60, sensor unlocked.

The antitheft device according to one or more embodiments of the invention may be applied to any portable device that it is desired to pair with another device, one being the controller of the other, when normal use of the portable device requires sharing between several users. It is possible, for example, to have a station having integrated software making it possible to command, via a man-machine interface, a removal of the disabled state of the unlocking of the portable device.

In the context of standard use, the main advantage of the antitheft device according to one or more embodiments of the invention is that there is no sharing of keys between various users but only shared use of the existing medical imaging hardware management system in a manner that is independent of the antitheft protection.

Another advantage of the device according to one or more embodiments of the invention is that, in standard use, it is not necessary to enter a code or even to have a key for each use of the sensor 4. What is advantageous, for example during intensive use of the sensor 4, is that the operations to be carried out to unlock the sensor 4 are then rapid and simple.

The sensor is locked advantageously simply by placing the sensor 4 on the docking station 3 with no other operation. This makes it possible to ensure that the sensor 3 is locked as soon as it is placed on the docking station 3.

Another advantage of the device is that it is simple to apply. Specifically, the device requires little addition to the existing hardware.

1. An antitheft device for a portable device, the antitheft device including a lockable attachment apparatus to attach the portable device to a docking device, wherein the antitheft device comprises:
an electromechanical system, to control unlocking of the lockable attachment apparatus by disablement of an electric signal by use of a command supplied by a user interface unit.

2. The antitheft device as claimed in claim 1, wherein the electric signal is disabled based on a disable message sent by the user interface unit to the docking device, said disable message generating a signal that is amplified by an amplifier to produce a first amplified signal, the first amplified signal preventing an output of a supply circuit of the electromechanical system from allowing unlocking of the antitheft device.

3. The antitheft device as claimed in claim 1, wherein the electric signal is enabled based on an enable message sent by the user interface unit to the docking device, said enable message generating a signal that is amplified by an amplifier to produce a second amplified signal, the second amplified signal allowing the output of the supply circuit of the electromechanical system to allow unlocking of the anti-theft device.

4. The antitheft device as claimed in claim 3, wherein an entry of a password via the user interface unit causes the enable message to be sent by the user interface unit and secures the use of the portable device.

5. The antitheft device as claimed in claim 2, wherein the disable message is sent automatically by the user interface unit at a programmable time.

6. The antitheft device as claimed in claim 1, wherein the electromechanical system comprises at least one electromagnet acting on a magnet connected to the lockable attachment apparatus, to allow the lockable attachment apparatus to be opened.

7. The antitheft device as claimed in claim 1, wherein the electric signal is generated by a button placed on the docking device.

8. The antitheft device as claimed in claim 1, wherein the electromechanical system comprises a mechanical unlocking means.

9. The antitheft device as claimed in claim 1, wherein the portable device comprises an X-ray sensor.

10. The antitheft device as claimed in claim 1, wherein the command to control the electric signal is supplied by a computer connected to the docking device via a link, wherein the computer is configured to store a medical imaging system management software program.
